(19) United States
(12) Patent Application Publication
(10) Pub. No.: US 2012/0320369 A1
(43) Pub. Date: Dec. 20, 2012

(54) OPTICAL MEASUREMENT SYSTEM AND THE DEVICE THEREOF

(75) Inventors: Hsu-Ting Cheng, Taoyuan Hsien (TW); I-Shih Tseng, Taoyuan Hsien (TW); Tsun-I Wang, Taoyuan Hsien (TW)

(73) Assignee: CHROMA ATE INC., Taoyuan Hsien (TW)

(21) Appl. No.: 13/252,425

(22) Filed: Oct. 4, 2011

(30) Foreign Application Priority Data
Jun. 17, 2011 (TW) 100121199

(51) Int. Cl. G01J 1/42; G01J 3/28; G01N 21/17

(52) U.S. Cl. 356/73; 356/218; 356/326

(57) ABSTRACT

The invention discloses an optical measurement system for measuring the optical properties of a device under test (DUT). The optical measurement system includes a DUT, a light measuring module, a light guiding module and an analyzing module. The present invention utilizes the light guiding module to receive an axial ray of the rays emitted by the DUT so as to analyze the optical properties thereof. Thus, the present invention is not only capable of measuring the light intensity of the rays emitted by the DUT, but also capable of obtaining the properties of the axial ray emitted by the DUT.

### BACKGROUND OF THE INVENTION

1. Field of the Invention

The present invention relates to an optical measurement system, and more particularly, to an optical measurement system which can measure total luminous fluxes of a device under test (DUT) and a plurality of optical properties of an axial ray at the same time.

2. Description of the Prior Art

When an LED probe station measures each device under test (DUT), an integrating sphere or a photo detector with large area are used to measure light energy for all angles. Accordingly, total luminous fluxes, color temperatures, color coordinates, color rendering indexes, spectra or other optical properties can be obtained. As the production of the DUT is on the increase, the demands of the DUT measurement become severe.

However, the integrating sphere may cause energy loss because of multiple reflections. Ideally, each integrating sphere can only measure one DUT. Thus, to prove the said problems, manufacturers tend to utilize the photo detector with large area to measure the DUT.

When measuring a plurality of optical properties of the DUT, the central part of the photo detector with large area is caved to receive an axial ray or a lateral ray is received from the outer part of the photo detector for obtaining the plurality of optical properties of the DUT. However, the said methods will cause the energy loss or the poor wavelength repeatability.

To sum up, it is an important issue about how to develop an inexpensive optical measurement system with high efficiency, for avoiding the energy loss and the poor wavelength repeatability.

### SUMMARY OF THE INVENTION

Accordingly, a scope of the invention is to provide an optical measurement system which can measure total luminous fluxes of a device under test (DUT) and a plurality of optical properties of an axial ray at the same time.

A scope of the invention is to provide an optical measurement. The optical measurement system comprises a DUT, a light measuring module, a light guiding module, and an analyzing module. The DUT is used to receive a power and generate a first ray and a second ray. The light measuring module is used to receive the second ray and measure a light intensity of the second ray. The light guiding module is disposed between the DUT and the light measuring module. The light guiding module is utilized to transmit the first ray and change a moving direction of the first ray. The light guiding module comprises a light input terminal, a light output terminal and a guiding part. The light input terminal is formed at an end of the light guiding module, for reflecting the first ray and changing the moving direction of the first ray. The light output terminal is formed at another end related to the said end of the light guiding module, for changing the moving direction of the first ray and outputting the first ray. The guiding part is formed between the light input terminal and the light output terminal, for transmitting the first ray from the light input terminal toward the light output terminal. The analyzing module is used to receive the first ray from the light guiding module so as to measure a plurality of optical properties of the first ray.

Another scope of the invention is to provide an optical device. The optical measurement system comprises a bearing seat, a light measuring module, a light guiding module and an analyzing module. The bearing seat is used to install the DUT. The light measuring module comprises an illuminated face, wherein the illuminated face is toward the bearing seat for measuring a light intensity emitted by the DUT. The light guiding module is disposed between the bearing seat and the light measuring module. The light guiding module comprises a light input terminal and a light output terminal. The light input terminal is formed at a position corresponding to a central part of the illuminated face, for receiving an axial ray generated by the DUT. The light output terminal is formed at a position corresponding to an outer part of the illuminated face, for outputting the axial ray generated by the DUT. The analyzing module is used to receive and analyze the axial ray transmitted by the light guiding module.

### BRIEF DESCRIPTION OF THE APPENDED DRAWINGS

FIG. 1 illustrates a schematic diagram of an optical measurement system according to the invention.

FIG. 2 illustrates a schematic diagram of a light guiding module of an optical measurement system according to the invention.

### DETAILED DESCRIPTION OF THE INVENTION

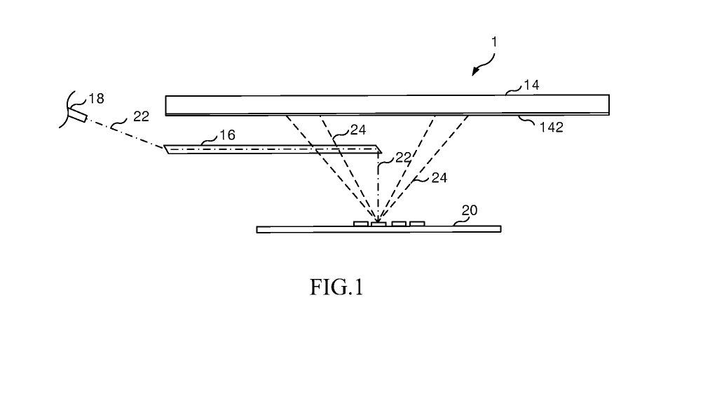

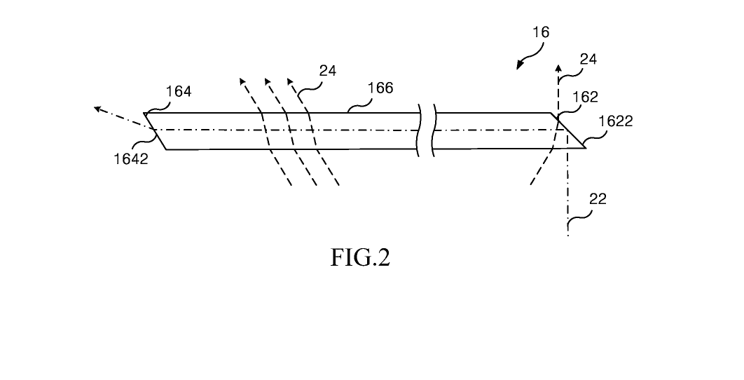

The invention discloses an optical measurement system. More particularly, the invention discloses an optical measurement system which can measure total luminous fluxes of a device under test (DUT) and a plurality of optical properties of an axial ray at the same time. Please refer to FIG. 1 and FIG. 2. FIG. 1 illustrates a schematic diagram of an optical measurement system according to the invention. FIG. 2 illustrates a schematic diagram of a light guiding module of an optical measurement system according to the invention. The optical measurement system 1 comprises a DUT 12, a light measuring module 14, a light guiding module 16, an analyzing module 18 and a bearing seat 20.

The device under test 12 means that an electronic component which can transform a power into a luminous energy. In a preferred embodiment, the DUT 12 can be an LED bare die. More particularly, the DUT 12 is an LED bare die divided and arranged trimly. However, the DUT 12 can be, but not limited to the LED bare die. The DUT also can be a laser diode die, an ultraviolet diode die or other electronic components which can receive the power to output the luminous energy. The DUT 12 is installed on the bearing seat 20. After receiving the power, the DUT will transform the power into the luminous energy and generate a first ray 22 and a second ray 24. In the invention, the first ray means that a ray emitted by the DUT 12 and transmitted to the analyzing module 18 through the light guiding module 16. Additionally, the second ray 24 means that a ray emitted by the DUT 12 and transmitted to the light measuring module 14. The first ray 22 and the second ray 24 will be further explained soon after. The bearing seat 20 means that a device which can bear dies. In the embodiment, the bearing seat 20 can be, but not limited to a wafer bearing device. The bearing seat 20 also can be a blue film or other devices which can bear the wafers.

The light measuring module 14 means that a device which can be utilized to measure the ray emitted by the DUT 12 and generates signals or data correspondingly. In the embodiment, the light measuring module 14 is a photoelectric converting module. More particularly, the light measuring module 14 is a solar cell. The light measuring module 14 comprises an illuminated face 142 which is toward the bearing seat 20 for receiving the second ray 24 emitted by the DUT 12 and measuring a light intensity of the second ray 24. In the embodiment, the light intensity is total luminous fluxes. Total luminous fluxes mean that a summary of luminous fluxes for all rays emitted by the DUT 12. However, the light intensity can be, but not limited to the luminous flux. The light intensity also can be an illumination or other equivalent units or values.

The light guiding module 16 is utilized to guide and receive the rays with specific angles which are emitted by the DUT 12. More particularly, the light guiding module 16 can be an optical component which can receive the rays with specific moving directions and angles which are emitted by the DUT 12, and guide the rays to the analyzing module 18. Compared to the prior art, the light guiding module 16 is disposed between the DUT 12 and the light measuring module 14 without covering a large area of the light measuring module 14.

In the embodiment, the light guiding module 16 can be, but not limited to a transparent rod for transmitting the first ray 22 and changing the moving direction of the first ray 22. In the invention, the light guiding module 16 comprises a light input terminal 162, a light output terminal 164 and a guiding part 166. Wherein, the light guiding module 16 is an integrally-formed structure and manufactured by transparent materials.

The light input terminal 162 is formed at an end of the light guiding module which is close to the DUT 12 and at a position corresponding to a central part of the illuminated face 142. The light input terminal 162 comprises a reflecting structure 1622 for reflecting the first ray 22 and changing the moving direction of the first ray 22. Because the light guiding module 16 is manufactured by transparent materials, the reflecting structure 1622 reflects the first ray 22 by a way of total internal reflection. The reflecting structure 1622 reflects the rays which have incident angles larger than a total internal reflection critical angle. Otherwise, the rays penetrate the reflecting structure 1622 and reach the light measuring module 14. Additionally, a user can select the incident angles of the rays by adjusting shapes of the reflecting structure 1622.

The guiding part 166 is formed between the light input terminal 162 and the light output terminal 164, for transmitting the first ray 22 from the light input terminal 162 toward the light output terminal 164. To be noticed, the guiding part 166 is manufactured by transparent materials, so that the rays can pass through the guiding part 166 except the first ray 22.

The light output terminal 164 means that an end of the light guiding module 16 which is close to the analyzing module 18 and at a position corresponding to an outer part of the illuminated face 142. More particularly, the light output terminal 164 is formed at another end related to the said end of the light guiding module 16. The light output terminal 164 is used to change the moving direction of the first ray 22 and output the first ray 22. Additionally, the light output terminal 164 has a function to change the moving direction of the first ray 22. To be noticed, the light output terminal 164 comprises a refractive structure 1642. The refractive structure 1642 is used to refract the first ray 22 so as to change the moving direction of the first ray 22.

The analyzing module 18 is used to receive the first ray 22 from the light guiding module 16 so as to measure a plurality of optical properties of the first ray 22. In the embodiment, the analyzing module 18 is a spectrometer. By the said method, the plurality of optical properties of the first ray 22 can be obtained by the analyzing module 18. Additionally, the first ray 22 emitted by the DUT 12 is an axial ray. The axial ray means that the moving direction of the first ray 22 which is almost perpendicular to a plane comprising the DUT 12. More particularly, “almost perpendicular” means that emergent angles are larger than 30 degrees. Furthermore, the analyzing module 18 is used to analyze color temperatures, color coordinates, color rendering indexes, spectra or other optical properties of the first ray 22.

Compared to the prior art, the invention is to provide an inexpensive optical measurement system with high efficiency for avoiding the energy loss and the poor wavelength repeatability. Additionally, the invention uses the light guiding module in the optical measurement system for receiving the axial ray emitted by the DUT. Differently, the light guiding module is transparent and disposed between the DUT and the light measuring module. Thus, the light guiding module guides the axial ray without obstructing the moving direction of the ray emitted by the DUT. Accordingly, Total luminous fluxes and the plurality of optical properties of the rays emitted by the DUT can be measured accurately.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An optical measurement system, comprising:
a device under test (DUT) for receiving a power and generating a first ray and a second ray;
a light measuring module for receiving the second ray and measuring a light intensity of the second ray;
a light guiding module disposed between the DUT and the light measuring module, wherein the light guiding module is utilized to transmit the first ray and change a moving direction of the first ray, the light guiding module comprising:
a light input terminal formed at an end of the light guiding module, for reflecting the first ray and changing the moving direction of the first ray;
a light output terminal formed at another end related to the said end of the light guiding module, for changing the moving direction of the first ray and outputting the first ray; and
a guiding part formed between the light input terminal and the light output terminal, for transmitting the first ray from the light input terminal toward the light output terminal; and
an analyzing module for receiving the first ray from the light guiding module so as to measure a plurality of optical properties of the first ray.

2. The optical measurement system of claim 1, further comprising a bearing seat for installing the DUT.

3. The optical measurement system of claim 1, wherein the light measuring module is a solar cell.

4. The optical measurement system of claim 1, wherein the analyzing module is a spectrometer.

5. The optical measurement system of claim 1, wherein the light input terminal further comprises a reflecting structure for reflecting the first ray so as to change the moving direction of the first ray.

6. The optical measurement system of claim 1, wherein the light output terminal further comprises a refractive structure for refracting the first ray so as to change the moving direction of the first ray.

7. An optical measurement device, comprising:
a bearing seat for installing a device under test (DUT);
a light measuring module comprising an illuminated face, wherein the illuminated face is toward the bearing seat for measuring a light intensity emitted by the DUT;
a light guiding module disposed between the bearing seat and the light measuring module, comprising:
a light input terminal formed at a position corresponding to a central part of the illuminated face, for receiving an axial ray generated by the DUT; and
a light output terminal formed at a position corresponding to an outer part of the illuminated face, for outputting the axial ray generated by the DUT; and
an analyzing module for receiving and analyzing the axial ray transmitted by the light guiding module.

8. The optical measurement device of claim 7, wherein the light measuring module is a solar cell.

9. The optical measurement device of claim 7, wherein the analyzing module is a spectrometer.
